(19) United States
(12) Patent Application Publication
(10) Pub. No.: US 2005/0262001 A1
(43) Pub. Date: Nov. 24, 2005

(54) Method of facilitating rights transfer and financial instrument for effecting same

(76) Inventor: Jeffrey B. Stewart, Atlanta, GA (US)

Correspondence Address: BRYAN W. BOCKHOP, ESQ., 2375 MOSSY BRANCH DR., SNELLVILLE, GA, 30078, US

(21) Appl. No.: 10/842,230

(22) Filed: May 10, 2004

(51) Int. Cl. G06F 17/60

(52) U.S. Cl. 705/36

(57) ABSTRACT

In a method for effecting rights transfer from a first entity to a second entity, a financial instrument is issued to the first entity in exchange for a right granted from the first entity. The financial instrument has a component that includes a cumulative royalty account representative of a cumulative royalty amount. A royalty amount to be credited the cumulative royalty account is calculated periodically and is based on a predetermined royalty schedule. On a conversion event, an average price per value unit for the second entity is determined. The financial instrument is converted into value units by dividing the cumulative royalty amount in the cumulative royalty account by the average price per value unit. The converted value units are issued to the first entity.

### BACKGROUND OF THE INVENTION

1. Field of the Invention

The invention relates to methods of managing financial transactions and, more specifically, to a method of managing a financial transaction involving a transfer of rights.

2. Description of the Prior Art

Transfers of rights from those who develop or otherwise acquire the rights (transferors) to those who commercialize the rights (transferees) are critical to economic progress. In one illustrative example, a research institution, such as a university, develops rights in new technology (such through patent and trade secret rights) and transfers the rights to an emerging technology company.

The Bayh-Dole Act requires licensors of inventions made with US Federal funding to show a preference for licensing inventions to start-up and small companies. The 2002 AUTM Survey reports that 68.2% of licenses granted by universities, hospitals and research institutions were to start-up and small companies, of which 14.6% of licenses were made to start-up companies (i.e., companies established specifically to develop the licensed technology), 54.1% were made to small companies (companies with less than 500 employees), and the remaining 31.8% were made to large companies. It is interesting to further note that 91% of the licenses to small companies were exclusive licenses, versus 45% for small companies and 39% for large companies.

Most universities have a technology transfer office that is responsible for licensing technology developed at the university to companies that can exploit the technology. Typically, the university demands either a cash royalty resulting from the technology or an equity stake in the company. According to one survey, seventy-two per cent of the time that technology was licensed by universities to start-up or early stage companies, the companies issued stock to the universities in consideration of such licenses. The remaining twenty-eight per cent of the time, such companies agreed to pay the universities cash royalties for the license of the technology.

With one approach to the equity model, the company grants non-dilutable equity to the university, in which the university will own a fixed percentage of the company throughout the company's life. This approach is generally sought by the university, as it could stand to reap substantial rewards if the company becomes successful. However, the increased value of the company could be attributable to factors other than the transferred technology (such as aggressive marketing or unrelated product development) and, therefore, the reward to the university could be disproportionate to its contribution to the company. Furthermore, if the equity stake granted to the university is fixed, then the company might have difficulty attracting subsequent investors, as the available investor equity is diminished by the amount of equity granted to the university.

Another approach to the equity model is where the company grants dilutable equity to the university. In this model, the university's stake in the company is diluted by the granting of equity to subsequent investors. In this model, as the company grows through substantial subsequent investment, the value to the university can be diluted to the point where technology transfer is of little value. Partly as a result of this situation, one organization has estimated that about seventy per cent of university discoveries are never licensed out of the universities for commercialization.

When equity of the start-up company is used for the license of the technology from the university, the company worries about giving up too much equity, while the university worries about not getting enough equity, relative to the future value of the technology. Furthermore, the return from the amount of equity granted might not reflect accurately the contribution made to the company by the technology, relative to other facets of the company's growth (e.g., marketing, subsequent investment, etc.).

The cash royalty model, on the other hand, may not be favored by an emerging technology company, as a substantial amount of revenue in the form of royalties may be required of the company at a phase of the company's growth during which the company can least afford to pay royalties. When cash royalties are to be paid by the start-up company, (1) the problem for the universities is that cash royalties may not fully reward the universities for taking the risk of licensing the technology to a start-up company; and (2) the problem for the company is that the payment of cash royalties represents a charge to earnings and a reduction of cash flow of the company. This can reduce the company's ability to grow and make obtaining additional equity financing more difficult.

Therefore, there is a need for a system to facilitate transfer of rights that rewards the transferor, while minimizing the impact on the transferee.

There is also a need for a system to facilitate transfer of rights that does not result in a charge to earnings in the early stages of a company's life, while compensating the grantor of rights at a desirable level.

### SUMMARY OF THE INVENTION

The disadvantages of the prior art are overcome by the present invention which, in one aspect, is a method for effecting a rights transfer from a first entity to a second entity in which a right is transferred from the first entity to the second entity on a transfer event. The second entity issues to the first entity, in response to the right transferring step, a royalty-based financial instrument that is binding on the second entity to the first entity. The financial instrument has a first component that includes a cumulative royalty account into which royalties are credited so as to determine a total cumulative royalty amount. The financial instrument also has a second component that includes a provision to convert the royalty-based financial instrument into a number of value units of a second financial instrument, the number of value units determined by dividing the total cumulative royalty amount by a conversion price per value unit. After the transfer event and for so long as the royalty-based financial instrument is outstanding, the royalty amount that has accrued since an immediate prior calculation date is calculated on a periodic basis. The royalty rate is based upon a portion of revenues of the second entity since the prior calculation date based on use of the right by the second entity. The royalty amount is credited to the cumulative royalty account. Upon conversion on a conversion date of the royalty-based financial instrument into the second financial instrument, the cumulative royalty amount in the cumulative royalty account is determined to arrive at the total cumulative royalty amount. The total number of value units of the second financial instrument that are issued and outstanding on the conversion date is determined. A total amount paid to the second entity for all issued and outstanding value units of the second financial instrument is determined. An average amount paid per issued and outstanding value units of the second financial instrument is determined. The total cumulative royalty amount is divided by the conversion price per value unit to arrive at a total number value units of the second financial instrument into which the royalty-based financial instrument is convertible. The royalty-based financial instrument is converted into the total number value units of the second financial instrument into which the royalty-based financial instrument is convertible.

In another aspect, the invention is a method for effecting rights transfer from a first entity to a second entity in which a financial instrument is issued at an issue event to the first entity in exchange for a right granted from the first entity to the second entity. The financial instrument is binding on the second entity. The financial instrument has a component that includes a cumulative royalty account representative of a cumulative royalty amount. After the issue event, a royalty amount to be credited the cumulative royalty account during a relevant timeframe is calculated periodically. The royalty amount is based on a predetermined royalty schedule. The relevant timeframe is an amount of time from the issue event to a predetermined conversion event. Upon occurrence of a predetermined conversion event an average price per value unit for the second entity averaged over the relevant timeframe is determined. The financial instrument is converted into value units by dividing the cumulative royalty amount in the cumulative royalty account by the average price per value unit, thereby generating a converted value unit amount. The converted value unit amount of value units of the second entity is issued to the first entity.

In another aspect, the invention is a method of accruing value in a financial instrument issued to a first entity to by a second entity. At an issue event, the financial instrument is issued to the first entity, so as to be binding on the second entity. The financial instrument is assigned a component that includes a cumulative royalty account representative of a cumulative royalty amount. After the issue event, a royalty amount to be credited the cumulative royalty account during a relevant timeframe is calculated periodically, based on a predetermined royalty schedule. The cumulative royalty amount is credited with the periodic royalty amount. The value of the financial instrument is set equal to the cumulative royalty amount at a preselected time.

In another aspect, the invention is a method of determining an average value of value units of an entity over a relevant timeframe. A summed value unit price during the relevant timeframe including a plurality of temporally spaced apart moments is created. A current value unit market price of a value unit of the entity of the value units at each of the moments is determined. Each current value unit market price is summed to generate the summed value unit price. The summed value unit price is divided by a total number of outstanding value units issued by the entity on a fully diluted basis, thereby generating the average value unit price.

In another aspect, the invention is a financial instrument that includes, in exchange for a grant from a first entity to a second entity, an obligation for the second entity to issue to the first entity, at a predetermined future date, an amount of value units of the second entity based on a cumulative royalty account. The instrument includes an obligation to credit a royalty amount according to a predetermined royalty rate into the cumulative royalty account. The instrument further includes an obligation to convert the financial instrument into a converted amount of value units issued by the second entity upon occurrence of the predetermined conversion event, the converted amount being equal to the cumulative royalty account divided by an average per value unit for the second entity, the average value unit price for the second entity being a summed value unit price taken at discrete moments from a date of issue of the financial instrument to the predetermined conversion event divided by a total number discrete moments at which the value unit prices were summed. The instrument also includes an obligation to issue value units of the second entity to the first entity in the amount of the converted amount.

In yet another aspect, the invention is a royalty-based financial instrument that has a component that includes a cumulative royalty account to which royalties are credited to determine a total cumulative royalty amount. A component of the instrument includes a right to convert, on a conversion date, the royalty-based financial instrument into a number of value units of the second financial instrument. The number of value units is determined by dividing the total cumulative royalty amount by a conversion price per value unit. After an issuance event and for so long as the royalty-based financial instrument is outstanding, a royalty amount that has accrued since an immediately prior calculation date is calculated on a periodic basis. The royalty amount is based upon a portion of revenues of the second entity since the immediately prior calculation date. The royalty amount is credited to the cumulative royalty account.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram showing one illustrative embodiment of the invention.

FIG. 2 is a is a flow chart showing implementation of one illustrative embodiment of a royalty accruing aspect of the invention.

FIG. 3 is a is a flow chart showing implementation of one illustrative embodiment of a conversion aspect of the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

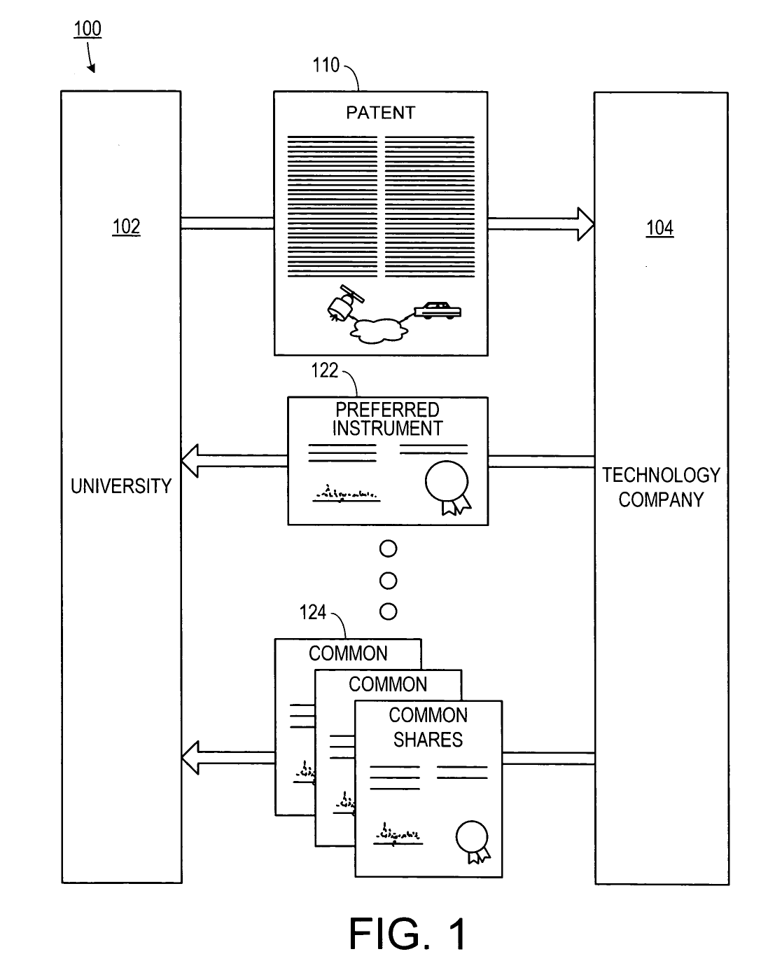

As shown in FIG. 1, one embodiment of the invention is a system 100 in which a first entity 102, such as a university, transfers a right 110, such as a license to a patent or other intellectual property, to a second entity 104, such as a technology company. While the embodiment discussed here shows the first entity 102 to be a university, it is understood that many other types of entities could be the first entity. For example, the first entity 102 could be a research institution, a land holder, a holder of mineral rights, or any entity that holds a transferable right. Similarly, while the right 110 shown in FIG. 1 is a patent, it is understood that the right 110 could include any of the many intellectual property rights (such as copyright, trade secrets, trademark, know how, etc.), a real property right, a mineral right, or any right that is transferable.

In exchange for the transfer of the right 110, the second entity 104 issues to the first entity 102 (the issuee) a financial instrument 122 (which can take the form of a preferred equity instrument) that sets forth a royalty rate in which the royalties are not paid out directly, but are credited to a cumulative royalty account as a component of the financial instrument 122. At a conversion event, set forth in the financial instrument 122, an average price per value unit (e.g., common shares) 124 of the second entity (such as average price per common share) is determined from the date the financial instrument 122 issues until the conversion event. The amount in the cumulative royalty account is then divided by the average price per value unit 124 to render a total number of value units 124 due to the first entity 102 from the second entity 104. Thus, the first entity 102 is granted value units in the second entity 104, not at the current market price of the value units at the time of the conversion event, but averaged from the time that the financial instrument 122 was issued.

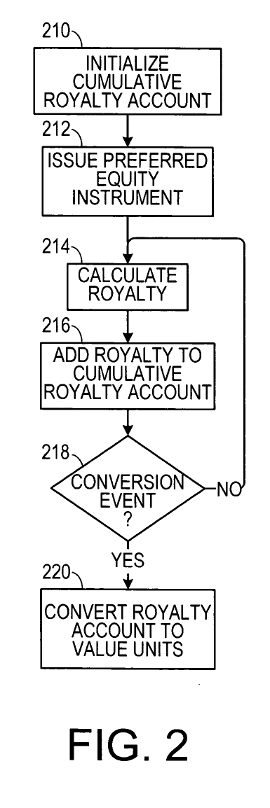

As shown in FIG. 2, in one method of implementing the invention, which may be executed with the aid of a computer, a royalty account is initialized 210 (typically to zero) and a financial instrument (such as a preferred equity instrument) is issued 212 from the first entity to the second entity. The financial instrument includes a royalty rate provision. Periodically, a current royalty amount due is calculated 214 and added to a cumulative royalty account 218. This accumulation of royalty continues until a conversion event 218, at which point the amount in the royalty account is converted 220 into value units (such as shares of common stock). The conversion event 218 could be an event such as an initial public offering, a liquidation of the company, a reorganization, or the financial instrument might allow the first entity to choose the conversion event at is sole discretion. As is understood by those of skill in the art, the parameters of the conversion event could be set to whatever is desired by the parties at the time the instrument is issued.

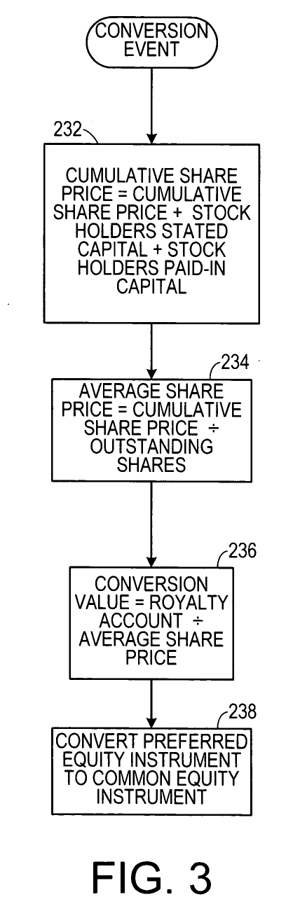

As shown in FIG. 3, conversion may be accomplished, in one illustrative embodiment, by averaging the price of the value units from the time that the instrument was issued until the conversion event and then by dividing this number by the total number of shares outstanding on a fully diluted basis. Thus, valuation is performed retrospectively and the total summed value is divided by the total number of shares outstanding, including all shares that the second entity has issued or has an obligation to issue. This may be accomplished by summing the stock holders' stated capital plus the stock holders' paid in capital, to generate a cumulative share price 232. An average share price 234 is determined by dividing the cumulative share price by the total number of outstanding shares on a fully diluted basis (which includes all issued shares and all shares that the second entity has an obligation to issue). The conversion value of the cumulative royalty account is determined 236 by dividing the cumulative royalty account by the average share price and the financial instrument is converted 238 into this amount of value units.

In one embodiment, the invention also includes a provision for a liquidation right for the royalty-based financial instrument in which n the amount of the total cumulative royalty on a liquidation date if the second entity liquidates and the royalty-based financial instrument is not converted by the liquidation date.

The above described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

1. A method for effecting a rights transfer from a first entity to a second entity, comprising the steps of:
a. transferring a right from the first entity to the second entity on a transfer event;
b. issuing from the second entity to the first entity, in response to the right transferring step, a royalty-based financial instrument that is binding on the second entity to the first entity, the financial instrument having:
i. a first component that includes a cumulative royalty account into which royalties are credited so as to determine a total cumulative royalty amount; and
ii. a second component that includes a provision to convert the royalty-based financial instrument into a number of value units of a second financial instrument, the number of value units determined by dividing the total cumulative royalty amount by a conversion price per value unit;
c. after the transfer event and for so long as the royalty-based financial instrument is outstanding, calculating on a periodic basis the royalty amount that has accrued since an immediate prior calculation date, based upon a portion of revenues of the second entity since the prior calculation date based on use of the right by the second entity, and crediting the royalty amount to the cumulative royalty account; and
d. upon conversion on a conversion date of the royalty-based financial instrument into the second financial instrument, executing the following steps:
i. determining the cumulative royalty amount in the cumulative royalty account to arrive at the total cumulative royalty amount;
ii. determining the total number of value units of the second financial instrument that are issued and outstanding on the conversion date;
iii. determining a total amount paid to the second entity for all issued and outstanding value units of the second financial instrument;
iv. determining an average amount paid per issued and outstanding value units of the second financial instrument;
v. dividing the total cumulative royalty amount by the conversion price per value unit to arrive at a total number value units of the second financial instrument into which the royalty-based financial instrument is convertible; and
vi. converting the royalty-based financial instrument into the total number value units of the second financial instrument into which the royalty-based financial instrument is convertible.

2. The method of claim 1, further comprising the step of allowing for a conversion price per value unit equal to an average price per value unit paid to the second entity for all value units of the second financial instrument issued and outstanding on the conversion date of the royalty-based financial instrument.

3. The method of claim 1, further comprising the step of allowing for a liquidation right for the royalty-based financial instrument in the amount of the total cumulative royalty on a liquidation date if the second entity liquidates and if the royalty-based financial instrument is not converted by the liquidation date.

4. A method for effecting rights transfer from a first entity to a second entity, comprising the steps of:
a. issuing, at an issue event, a financial instrument, binding on the second entity, to the first entity in exchange for a right granted from the first entity to the second entity, the financial instrument having a component that includes a cumulative royalty account representative of a cumulative royalty amount;
b. after the issue event, periodically calculating a royalty amount to be credited the cumulative royalty account during a relevant timeframe, based on a predetermined royalty schedule, the relevant timeframe being an amount of time from the issue event to a predetermined conversion event; and
c. upon occurrence of a predetermined conversion event, executing the following steps:
i. determining an average price per value unit for the second entity averaged over the relevant timeframe;
ii. converting the financial instrument into value units by dividing the cumulative royalty amount in the cumulative royalty account by the average price per value unit, thereby generating a converted value unit amount; and
iii. issuing to the first entity the converted value unit amount of value units of the second entity.

5. The method of claim 4, wherein the value unit for the second entity comprises a share of common stock.

6. The method of claim 4, wherein the predetermined conversion event comprises an initial public offering of stock by the second entity.

7. The method of claim 4, wherein the predetermined conversion event comprises liquidation of the second entity.

8. The method of claim 4, wherein the predetermined conversion event comprises reorganization of the second entity.

9. The method of claim 4, wherein the first entity comprises a research institution.

10. The method of claim 4, wherein the right comprises an intellectual property right.

11. The method of claim 10, wherein the intellectual property right comprises a patent right.

12. The method of claim 10, wherein the intellectual property right comprises a trade secret right.

13. The method of claim 10, wherein the intellectual property right comprises a copyright.

14. The method of claim 4, wherein the right comprises a real property right.

15. The method of claim 14, wherein the real property right comprises a mineral right.

16. The method of claim 4, wherein the financial instrument comprises a preferred equity instrument.

17. The method of claim 4, wherein the step of determining an average price per value unit comprises the steps of:
a. determining a summed value unit price over the relevant timeframe by adding a stock holders stated capital for the second entity during the relevant timeframe to a stock holders paid-in capital for the second entity during the relevant timeframe; and
b. dividing the summed value unit price by a total number of outstanding value units issued by the second entity on a fully diluted basis, thereby generating the average price per value unit.

18. A method of accruing value in a financial instrument issued to a first entity to by a second entity, comprising the steps of:
a. issuing, at an issue event, the financial instrument to the first entity, so as to be binding on the second entity;
b. assigning to the financial instrument a component that includes a cumulative royalty account representative of a cumulative royalty amount;
c. after the issue event, periodically calculating a royalty amount to be credited the cumulative royalty account during a relevant timeframe, based on a predetermined royalty schedule;
d. crediting the cumulative royalty amount with the periodic royalty amount; and
e. setting the value of the financial instrument equal to the cumulative royalty amount at a preselected time.

19. A method of determining an average value of value units of an entity over a relevant timeframe, comprising the steps of:
a. creating a summed value unit price during the relevant timeframe including a plurality of temporally spaced apart moments:
i. determining a current value unit market price of a value unit of the entity of the value units at each of the moments; and
ii. summing each current value unit market price to generate the summed value unit price; and
b. dividing the summed value unit price by a total number of outstanding value units issued by the entity on a fully diluted basis, thereby generating the average value unit price.

20. A financial instrument, comprising:
a. in exchange for a grant of a right from a first entity to a second entity, an obligation for the second entity to issue to the first entity, at a predetermined future date, an amount of value units of the second entity based on a cumulative royalty account;
b. an obligation to credit a royalty amount according to a predetermined royalty rate into the cumulative royalty account;
c. an obligation to convert the financial instrument into a converted amount of value units issued by the second entity upon occurrence of the predetermined conversion event, the converted amount being equal to the cumulative royalty account divided by an average value unit price, the average value unit price comprising a total stated capital and a total paid in capital for the value units divided by the total number of outstanding value units on a fully-diluted basis; and
d. an obligation to issue value units of the second entity to the first entity in the amount of the converted amount.

21. A royalty-based financial instrument, comprising:
a. a component that includes a cumulative royalty account to which royalties are credited to determine a total cumulative royalty amount;
b. a component that includes a right to convert, on a conversion date, the royalty-based financial instrument into a number of value units of the second financial instrument, the number of value units being determined by dividing the total cumulative royalty amount by a conversion price per value unit; and
c. after an issuance event and for so long as the royalty-based financial instrument is outstanding, calculating on a periodic basis a royalty amount that has accrued since an immediately prior calculation date, based upon a portion of revenues of the second entity since the immediately prior calculation date, and crediting the royalty amount to the cumulative royalty account.

22. The instrument of claim 21, further comprising a component by which a conversion price per value unit is equal to an average price per value unit paid to the second entity for all value units of the second financial instrument issued and outstanding on the conversion date of the royalty-based financial instrument.

23. The method of claim 21, further comprising a component by which a liquidation right for the royalty-based financial instrument is in the amount of the total cumulative royalty on a liquidation date if the second entity liquidates and the royalty-based financial instrument is not converted by the liquidation date.
